(19) United States
(12) Patent Application Publication
(10) Pub. No.: US 2005/0197458 A1
(43) Pub. Date: Sep. 8, 2005

(54) Perfluoroelastomer molded article having non-sticking property to metal and method for producing the same

(76) Inventors: Takeshi Kuboyama, Shizuoka (JP); Katsumi Watanabe, Shizuoka (JP)

Correspondence Address: NIXON & VANDERHYE, PC, 901 NORTH GLEBE ROAD, 11TH FLOOR, ARLINGTON, VA, 22203, US

(21) Appl. No.: 11/037,450

(22) Filed: Jan. 19, 2005

(30) Foreign Application Priority Data
Jan. 20, 2004 (JP) P . 2004-011710

(51) Int. Cl. C08F 8/00

(52) U.S. Cl. 525/191

(57) ABSTRACT

The present invention provides a perfluoroelastomer molded article having non-sticking property to metal, which comprises: a perfluoroelastomer crosslinked molded article; and an amorphous fluororesin that coats the perfluoroelastomer crosslinked molded article. Also disclosed are a method for producing the perfluoroelastomer molded article and a rubber material comprising the perfluoroelastomer molded article.

### FIELD OF THE INVENTION

The present invention relates to a perfluoroelastomer molded article reduced in sticking property and adhesion property to metal, that is, having non-sticking property to metal, in a high-temperature environment. The invention particularly relates to a non-sticky perfluoroelastomer molded article suitable for equipment and parts for manufacturing or handling semiconductors, liquid crystal devices or food, or medical parts. Further, the invention relates to a method for producing such a non-sticky perfluoroelastomer molded article.

### BACKGROUND OF THE INVENTION

Rubber seal materials such as rubber O-rings used in manufacturing equipment of semiconductors or liquid crystal devices are required to have cleanness such as low metal elution and low gas release for preventing the outside from being contaminated. In particular, rubber materials for semiconductor manufacturing equipment are required to have heat resistance, radical resistance, chemical resistance and the like, as well as cleanness Therefore, perfluoro rubbers excellent in heat resistance and plasma resistance have been frequently used.

However, rubber materials often stick to metal surfaces to be sealed, which brings about the fatal problems of inhibiting the normal operation of equipment and the like at sites where opening and closing are frequently performed. At the time of maintenance, the seal materials adhere so strongly that they cannot be peeled off. When they are forcedly peeled off, rubber powders fall by rubbing, and even adversely affect the equipment later in some cases.

On the other hand, fluorine-based polymers have been considered to be rubber materials which are most difficult to stick to metal, because of their low surface energy. However, they show extremely high sticking strength, contrary to expectations. In particular, the perfluoro rubber seal materials have many opportunities to be exposed to vacuum or high temperatures, so that this problem becomes remarkable. Accordingly, an effective technique for reducing adhesion property or sticking property has been demanded.

As methods for reducing adhesion of rubber, there have been known (1) incorporation of oil into rubber, (2) treatment of forming a silicone reactive layer on the surface of a rubber material (see, for example, patent document 1), (3) treatment of impregnating a neighborhood of the surface of a rubber material with a crosslinking agent, followed by heating to increase crosslink density in the neighborhood of the surface (see, for example, patent document 2), (4) blending with a silicone rubber (see, for example, patent document 3), (5) filling of a fluororesin powder or the like into a rubber (see, for example, patent document 4), (6) irradiation with a specific kind of plasma, and the like.

However, the method (1) suffers from the problems of contamination caused by oil exudation and decreased strength of the material itself. According to the method (2), the perfluoro rubber material is used in a high-temperature environment of 200° C. or more in many cases, so that the silicone, and an amido bond and a urethane bond binding the silicone to the rubber surface are thermally deteriorated to fail to exhibit non-adhesion property. The method (3) increases the crosslink density through a dehydrofluorination process, so that it is impossible to treat perfluoro rubber materials in which vinylidene fluoride is not copolymerized. The method (4) also causes thermal deterioration of the silicone rubber and insufficient non-adhesion property, and has a disadvantage in that the strength of the perfluoro rubber material decreases. According to a simple filling method such as the method (5), the resin powder appears on a surface layer in small amounts, so that sufficient non-adhesion property is not exhibited. When the filling amount of the resin powder is increased in order to solve this problem, there arise the problems of decreased elasticity and strength of the rubber material and deterioration in crosslink moldability. According to the method (6), the plasma-etched rubber surface becomes uneven to remarkably deteriorate sealing properties.
Patent Document 1: JP 1-301725 A
Patent Document 2: JP 5-21931 B
Patent Document 3: JP 5-339456 A
Patent Document 4: Japanese Patent No. 3009676

As described above, according to the conventional art, it has been difficult to impart non-sticking property and non-adhesion property to perfluoro rubber materials for use in a clean environment and in a severe environment such as a high-temperature or vacuum environment.

### SUMMARY OF THE INVENTION

It is therefore an object of the invention to provide a perfluoroelastomer molded article which exhibits good non-sticking property and non-adhesion property, even when it is used in a clean environment and in a severe environment such as a high-temperature or vacuum environment, particularly in equipment and parts for manufacturing or handling semiconductors, liquid crystal devices or food, or medical parts.

Another object of the present invention is to provide a method for producing the perfluoroelastomer molded article.

A still other object of the present invention is to provide a rubber material comprising the perfluoroelastmer molded article.

A further still other object of the present invention is to provide various applications of the rubber material.

Other objects and effects of the invention will become apparent from the following description.

The present inventors have discovered that by coating with a specific fluororesin, a perfluoroelastomer molded article becomes difficult to stick or adhere to metal even when brought into contact with metal in a high-temperature environment.

That is, the invention provides a perfluoroelastomer molded article having non-sticking property to metal, which comprises:
a perfluoroelastomer crosslinked molded article; and
an amorphous fluororesin that coats the perfluoroelastomer crosslinked molded article.

In a preferred embodiment, the perfluoroelastomer molded article has a sticking force to a metal at a temperature of 200° C. to 300° C. that is 50% or less of the sticking force, to the metal, of the perfluoroelastomer crosslinked molded article not coated with the amorphous fluororesin.

In another preferred embodiment, the amorphous fluororesin has a glass transition temperature of 200° C. or more.

In a still other preferred embodiment, the amorphous fluororesin has a weight-average molecular weight of 5,000 to 300,000, and is soluble in a fluorosolvent.

In a still other preferred embodiment, the amorphous fluororesin has a fluorine content of 40% by weight or more, and is soluble in a fluorosolvent.

The invention also provides a method for producing a perfluoroelastomer molded article having non-sticking property to metal, which comprises the steps of:
dipping a perfluoroelastomer crosslinked molded article in a solution of an amorphous fluororesin dissolved in a fluorosolvent or coating the perfluoroelastomer crosslinked molded article with the solution;
performing air drying at room temperature; and then,
performing heat treatment at 50° C. or more.

Furthermore, the invention provides a rubber material comprising the perfluoroelastomer molded article for use in semiconductor manufacturing equipment, semiconductor conveyance equipment, liquid crystal device manufacturing equipment, food manufacturing equipment, food conveyance equipment, food storage equipment or medical parts.

In the perfluoroelastomer molded article having non-sticking property to metal of the invention, the coating fluororesin is amorphous, has an extremely high glass transition temperature, and is soluble in the fluorosolvent. Accordingly, the Brownian motion of molecules of a surface of the perfluoroelastomer molded article is not activated even at high temperatures, and the van der Waals force becomes difficult to act on hydroxyl groups and the like of a metal surface, which allows the formation of a low energy surface to show good non-sticking property and non-adhesion property to metal.

### DETAILED DESCRIPTION OF THE INVENTION

The invention will be described in detail below.

The perfluoroelastomer for use in the present invention can be obtained from a monomer mixture containing:
a perfluoroolefin monomer;
a perfluorovinyl ether monomer selected from the group consisting of a perfluoro(alkyl vinyl) ether, a perfluoro(alkoxy vinyl) ether and a mixture thereof; and
a cure site monomer selected from the group consisting of a nitrile-containing fluorinated olefin and a nitrile-containing fluorinated vinyl ether Further, the perfluoroelastomer may be a polymer in which a fourth ingredient such as vinylidene fluoride, hexafluoro-propylene or ethylene, as well as the perfluoroolefin monomer and the perfluorovinyl ether monomer, is copolymerized. Further, the perfluoroelastomer may be a polymer having a peroxide crosslink site such as iodine or bromine.

Further, according to need, the above-mentioned perfluoroelastomer can be mixed with an additive including: an inorganic filler such as carbon black, silica, barium sulfate, titanium oxide, aluminum oxide, calcium carbonate, calcium silicate, magnesium silicate, aluminum silicate, zinc oxide, red iron oxide and a clay mineral (for example, wollastonite or mica); an organic filler such as a polytetrafluoroethylene resin, a polyethylene resin, a polypropylene resin, a phenol resin, a polyimide resin, a melamine resin and a silicone resin; and fiber for reinforcement such as cotton, rayon fiber, nylon fiber and polyester fiber The strength, hardness, plasma resistance, radical resistance and non-sticking property of the crosslinked molded article can be enhanced by the incorporation of the above-enumerated additive.

As a method for crosslinking and molding the above-mentioned perfluoroelastomer, any method may be used. For example, it can be carried out by chemical crosslinking and molding using a chemical crosslinking agent. Alternatively, crosslinking can be performed by ionizing radiation after molding The chemical crosslinking and the ionizing radiation may be performed in combination. The molding method using the chemical crosslinking agent is more preferred. The chemical crosslinking does not require preforming which is required for the ionizing radiation crosslinking, and provides good moldability and also good mechanical strength of the molded article. In particular, the molded article obtained by using a chemical crosslinking agent, including an organotin compound-based crosslinking agent, a crosslinking agent such as a bisaminophenol, a tetraminophenol or a bisaminothiophenol, and a conventional peroxide crosslinking agent using fluorinated TAIC as a cocrosslinking agent, shows excellent heat resistance and chemical resistance.

The organotin compounds include, for example, allyltin, propargyltin, triphenyltin and allenyltin compounds, but are not limited thereto. Further, these crosslinking agents may be used together. Of these, tetraalkyltin compounds and tetraaryltin compounds are preferred. These compounds are useful crosslinking agents for a perfluoroelastomer having a nitrile-containing cure site. Further, the simultaneous use of a crosslinking accelerator can improve the crosslinking rate. The crosslinking accelerators include, for example, ammonium salts such as ammonium perfluorooctanoate, ammonium perfluoroacetate, ammonium thiocyanate and ammonium sulfamate, but are not limited thereto.

The bisaminophenols, the tetraminophenols and the bisaminothiophenols include, for example, 4,4′-[2,2,2-tri-fluoro-1-(trifluoromethyl)ethylidene]bis(2-aminophenol), 4,4′-sulfonylbis(2-aminophenol), 3,3′-diaminobenzidene, 3,3′,4,4′-tetraminobenzophenone and 2,2′-bis(3-mercapto-4-hydroxyphenyl)hexafluoropropane, but are not limited thereto. Further, these crosslinking agents may be used in a combination of two or more thereof.

The peroxide crosslinking agents include di-t-butyl peroxide, dicumyl peroxide, t-butylcumyl peroxide, 1,1-di(t-butylperoxy)-3,3,5-trimethylcyclohexane, benzoyl per-oxide, n-butyl-4,4-bis(t-butylperoxy) valerate, α,α′-bis-(t-butylperoxy)diisopropylbenzene, 2,5-dimethyl-2,5-bis(t-butylperoxy)hexane and 2,5-dimethyl-2,5-bis(t-butyl-peroxy)hexyne-3, but are not limited thereto. Further, these crosslinking agents may be used in a combination of two or more thereof.

A perfluoroelastomer molded article excellent in heat resistance and chemical resistance can be obtained by blending the above-mentioned crosslinking agent in an amount of 0.1 to 20 parts by weight per 100 parts by weight of the perfluoroelastomer.

When the chemical crosslinking is employed, secondary crosslinking by means of an oven or the like is generally performed, in addition to primary crosslinking by pres molding or the like. Also in the invention, it is preferred to perform secondary crosslinking by heating at a temperature of 150 to 350° C. for about 1 to 50 hours.

On the other hand, any kind of ionizing radiation is applicable in the invention, as long as it is an electromagnetic wave or particle beam having the ability to ionize air directly or indirectly. Examples thereof include but are not limited to an α-ray, a β-ray, a γ-ray, a deuteron beam, a proton beam, a neutron ray, an X-ray and an electron beam. These ionizing radiations may be used in combination. In the invention, a γ-ray is particularly preferably used. A γ-ray can realize uniform crosslinking because of its high penetrating power. Further, when a γ-ray is irradiated, the irradiation is preferably performed under vacuum or in an inert gas atmosphere. It is unfavorable that the irradiation is performed in an oxygen atmosphere, because the perfluoroelastomer may decompose in some cases.

When the ionizing radiation is irradiated, the crosslinking and decomposition of the perfluoroelastomer occur at the same time. Accordingly, when the amount of irradiation is too large, the physical properties deteriorate because of the decomposition of the perfluoroelastomer. On the other hand, when the amount of irradiation is too small, heat resistance deteriorates because of the lack of crosslinking of the perfluoroelastomer. In the invention, therefore, the irradiation amount of ionizing radiation is preferably within an appropriate range. The total irradiation amount of ionizing radiation is preferably from 10 to 500 kGy, more preferably from 30 to 350 kGy, and still more preferably from 60 to 300 kGy. The adjustment of the amount of ionizing radiation within the above-mentioned range provides a perfluoroelastomer crosslinked molded article having good physical properties.

The perfluoroelastomer crosslinked molded article obtained above is dipped in an amorphous fluororesin solution in a fluorosolvent, or coated with the solution. After air drying at room temperature, heat treatment is further performed at 50° C. or more. Thereby, the perfluoroelastomer molded article having non-sticking property to metal of the invention can be obtained.

The amorphous fluororesin stands on the premise that it is soluble in a fluorosolvent. Accordingly, a molecular weight control thereof is important. Further, it is preferred that the fluororesin has an extremely high glass transition temperature in order to decrease intermolecular forces with hydroxyl groups of a metal surface. Taking into consideration of imparting a moderate toughness to a coating of this amorphous fluororesin, in addition to that it is solvent-soluble, the weight-average molecular weight of the amorphous fluororesin is preferably from 5,000 to 300,000, and more preferably from 40,000 to 200,000. Further, the glass transition temperature is preferably from 200 to 300° C., and more preferably from 250 to 300° C., and is desirably higher than a temperature in the use environment of rubber.

As the amorphous fluororesin meeting such requirements, there can be exemplified a compound having an oxygen atom-containing 5-membered cyclic structure represented by the following general formula (I). The symbols n and m are each any integer, and selected so as to satisfy the above-mentioned molecular weight.

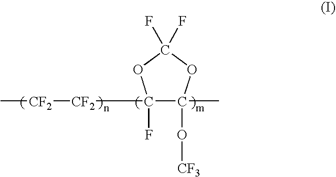

In the fluororesin represented by general formula (I), the adjustment of the fluorine content to 40% by weight or more results in an extremely high glass transition temperature. Preferably, the fluorine content is from 50 to 70% by weight. The inclusion of an oxygen atom imparts moderate molecular mobility to this fluororesin to make it amorphous, resulting in solubilization thereof in a fluorosolvent.

The fluorosolvent is preferably nonflammable from the viewpoint of safety, and there can be used, for example, HFC (hydrofluorocarbon), PFPE, HCFC and HFPE. Specific examples thereof include but are not limited to AK255 manufactured by Asahi Glass Co., Ltd.

As a method for applying a solution of the amorphous fluororesin, there is available a general coating method such as brush coating.

The temperature of heat treatment after air drying is 50° C. or more, and preferably form 70 to 200° C. It is necessary to carry out drying at a temperature lower than the glass transition temperature of the amorphous fluororesin and equal to or higher than the boiling point of the fluorosolvent. The heat treating time is 1 minute or longer, although it varies depending on the concentration of the amorphous fluororesin. Taking into consideration workability, fixing properties to the perfluoroelastomer crosslinked molded article and uniformity of the amorphous fluororesin coating, the time is preferably from 5 minutes to 3 hours.

Further, although there is no particular limitation on the film thickness of the coating comprising the amorphous fluororesin, it is suitably from 0.1 to 10 μm, taking into consideration sealing properties of the coating. In the adjustment of the film thickness, recoating and repetitive dipping are effective for increasing the thickness of the coating.

The perfluoroelastomer molded article of the invention thus obtained has a sticking force to a metal that is 50% or less of the sticking force, to the metal, of the perfluoroelastomer crosslinked molded article not coated with the amorphous fluororesin, in a high-temperature environment of 200° C. to 300° C. A measuring method will be described in detail in the Example below Accordingly, the perfluoroelastomer molded article of the invention is suitable for applications used in severe environments such as high-temperature or vacuum environments, such as semiconductor manufacturing equipment, semiconductor conveyance equipment, food manufacturing equipment, food conveyance equipment, food storage equipment and medical parts. For example, in the semiconductor manufacturing field, the molded article of the invention can be used in semiconductor manufacturing equipment such as a wet washing apparatus, a plasma etching apparatus, a plasma ashing apparatus, a plasma CVD apparatus, an ion injection apparatus and a sputtering apparatus, and wafer conveyance instruments which are auxiliary equipment of these apparatus. The invention also includes a rubber material comprising the perfluoroelastomer molded article for use in a semiconductor manufacturing equipment or semiconductor conveyance equipment, a food manufacturing equipment, food conveyance equipment or food storage equipment, or medical parts.

### EXAMPLE

The present invention will be illustrated in greater detail with reference to the following Example, but the invention should not be construed as being limited thereto.

In a stainless steel autoclave having a volume of 500 ml, 200 ml of distilled water, 2.5 g of ammonium per-fluorooctanoate and 4.4 g of Na₂HPO₄.12H₂O were charged, and then, the inside thereof was replaced by nitrogen gas, followed by pressure reduction. After cooling this autoclave to 50° C., 32 g of tetrafluoroethylene, 68 g of perfluoromethyl vinyl ether and 6.4 g of perfluoro-8-cyano-5-methyl-3,6-dioxa-1-octene were charged therein, and the temperature thereof was elevated to 80° C. Then, 0.75 g of sodium sulfite and 3.75 g of ammonium persulfate were each charged in the form of a 25-ml aqueous solution, and polymerization was initiated. After continuation of the polymerization for 20 hours, an unreacted gas was purged, and an aqueous latex formed therein was taken out. Then, the aqueous latex was subjected to a salting-out procedure using a 10% aqueous solution of sodium chloride, followed by drying to obtain 44 g of a crumb rubber-like ternary copolymer. From the results of infrared absorption analysis, this ternary copolymer had a copolymerization composition of 62 mol % of tetra-fluoroethylene, 37 mol % of perfluoromethyl vinyl ether and 1 mol % of a component having a nitrile group characteristic absorption of 2268 cm⁻¹.

Then, the following compounding components were kneaded by an open roll, and formed to a sheet having a thickness of 6 mm. Primary crosslinking was performed at 190° C. for 30 minutes and secondary crosslinking was performed at 260° C. for 48 hours to obtain a perfluoroelastomer molded article.

| | | |
|---|---|---|
| Ternary Copolymer | 100 | parts by weight |
| 2,2-Bis(3-amino-4-hydroxyphenyl)- | 1 | part by weight |
| hexafluoropropane | | |
| Dicyclohexyl-18-crown-6 | 2 | parts by weight |
| Zinc White | 2 | parts by weight |
| MT Carbon | 20 | parts by weight |

Then, a solution in which an amorphous fluororesin represented by general formula (I) and having a glass transition temperature of 260° C., a fluorine content of 60% and a weight-average molecular weight of 60,000 was dissolved in HFC (hydrofluorocarbon) was prepared. The above-mentioned perfluoroelastomer molded article was dipped in this solution for 10 seconds, and dried at room temperature for 1 minute, followed by heat treatment at 80° C. for 20 minutes.

The thus-obtained perfluoroelastomer molded article coated with the amorphous fluororesin and the above-mentioned perfluoroelastomer molded article not coated with the amorphous fluororesin were subjected to the following sticking test.

Sticking Test

A test piece having a thickness of 6 mm and a diameter of 10 mm was cut out from each molded article, and compressed while being interposed between SUS 316L plates having a thickness of 2 mm and a diameter of 90 mm, or between aluminum plates, from the both sides until the thickness of the test piece was reduced to 25%. The compression plates including the test piece were placed in a gear oven at 200° C. and allowed to stand for 22 hours. Then, the compression plates were cooled, and vertically pulled at a rate of 10 mm/sec with an autograph to measure the maximum load at that time.

The results are shown below. The perfluoroelastomer molded article coated with the amorphous fluororesin showed a sticking force of about one-third the sticking force of the perfluoroelastomer molded article not coated with the amorphous fluororesin.

The perfluoroelastomer molded article coated with the amorphous fluororesin.

Sticking force

80 [N] (SUS 316L)
50 [N] (aluminum)

The perfluoroelastomer molded article not coated with the amorphous fluororesin.

Sticking force

250 [N] (SUS 316L)
170 [N] (aluminum)

While the invention has been described in detail and with reference to specific embodiments thereof, it will be apparent to one skilled in the art that various changes and modifications can be made therein without departing from the spirit and scope thereof.

The present application is based on Japanese Patent Application No. 2004-011710 filed Jan. 20, 2004, the contents thereof being herein incorporated by reference

1. A perfluoroelastomer molded article having non-sticking property to metal, which comprises:
a perfluoroelastomer crosslinked molded article; and
an amorphous fluororesin that coats the perfluoroelastomer crosslinked molded article.

2. The perfluoroelastomer molded article according to claim 1, having a sticking force to a metal at a temperature of 200° C. to 300° C. that is 50% or less of the sticking force, to the metal, of the perfluoroelastomer crosslinked molded article not coated with the amorphous fluororesin

3. The perfluoroelastomer molded article according to claim 1, wherein the amorphous fluororesin has a glass transition temperature of 200° C. or more.

4. The perfluoroelastomer molded article according to claim 1, wherein the amorphous fluororesin has a weight-average molecular weight of 5,000 to 300,000, and is soluble in a fluorosolvent.

5. The perfluoroelastomer molded article according to claim 1, wherein the amorphous fluororesin has a fluorine content of 40% by weight or more, and is soluble in a fluorosolvent.

6. A method for producing a perfluoroelastomer molded article having non-sticking property to metal, which comprises the steps of:
dipping a perfluoroelastomer crosslinked molded article in a solution of an amorphous fluororesin dissolved in a fluorosolvent or coating the perfluoroelastomer crosslinked molded article with the solution;
performing air drying at room temperature; and then,
performing heat treatment at 50° C. or more.

7. A rubber material comprising the perfluoroelastomer molded article according to claim 1.

8. A rubber material comprising the perfluoroelastomer molded article according to claim 2.

9. A rubber material comprising the perfluoroelastomer molded article according to claim 3.

10. A rubber material comprising the perfluoroelastomer molded article according to claim 4.

11. A rubber material comprising the perfluoroelastomer molded article according to claim 5.
